(19) United States
(12) Patent Application Publication
(10) Pub. No.: US 2020/0003400 A1
(43) Pub. Date: Jan. 2, 2020

(54) Balanced Head Light

(71) Applicant: Liam Kelly, Midland Park, NJ (US)

(72) Inventor: Liam Kelly, Midland Park, NJ (US)

(21) Appl. No.: 16/267,384

(22) Filed: Feb. 4, 2019

Related U.S. Application Data
(60) Provisional application No. 62/625,339, filed on Feb. 2, 2018.

(51) Int. Cl. F21V 21/084; A42B 1/24; F21L 4/00

(52) U.S. Cl. CPC F21V 21/084; F21L 4/00; A42B 1/242

(57) ABSTRACT

The present invention is therefore designed provide a handsfree concentrated light beam that is directed at a targeted location. The light source is integrated with a head harness, which also houses a battery pack that is positioned in a such a way that creates a perfectly balanced device. The positioning of the battery pack ensures that the harness may be worn continuously without the risk of self-displacement on account of unbalanced weight. The battery back may be easily and quickly replaced. As an additional benefit, the head harness may be weather protected with a hat adornment that accommodates controls for the harness. The invention provides for weather proofing the harness by wrapping within a warm fabric wrap.

### CLAIM OF PRIORITY

This application claims prior of the U.S. Provisional Patent Application No. 62/625,339 filed on Feb. 2, 2018, the contents of which are fully incorporated herein by reference.

### FIELD OF THE INVENTION

The present invention relates to an accessory for hands free equipment, namely, a headlight.

### BACKGROUND OF THE INVENTION

Sufficiency of lighting is often the basic premise of whether an operation will go well or not. Often lighting is simply taken for granted by those working indoors, enjoying the benefits of a functional power grid. There are many important trades and endeavors for whom proper lighting is a luxury.

While many head worn light beam solutions exist, such as lights used by fire fighters, construction workers, miners and railroad workers, these solve the issue of general illumination. Targeted and concentrated light beams is a luxury reserved for indoor settings, or for large outdoor lighting devices, which are not sufficiently portable to be worn on person.

An additional problem is that lighting needs lots of energy, requiring long lasting batteries. During prolonged operations, electrical flow from a battery also generates heat. The weight of batteries and the challenge of dissipating heat they generate are prevalent and constant problems in this field of art. Solutions to these exist in the form of portable battery packs worn on a user's belt, or at a location on the head harness or headdress. However, the weight of these batteries creates a disbalance on a wearer's head. When a battery pack is worn on a user's belt, a wire that that runs between the belt and lighting device creates a risk of a snag or entanglement. There is also a real chance that the wire will be pulled out causing a technician to lose a source of light in what could be the middle of a significant medical procedure.

There is also the issue of being outdoors and in the cold. A head light worn on the head prevents a hat from being worn. While a user may wear a hat under the harness, a hat that is not connected with a harness may cause such a hat to slide down. A hat that is integrated with the harness, as is shown in the disclosed figures, is the preferred method of keeping warm.

The present invention is therefore designed provide a handsfree concentrated light beam that is directed at a targeted location. The light source is integrated with a head harness, which also houses a battery pack that is positioned in a such a way that creates a perfectly balanced device. The positioning of the battery pack ensures that the harness may be worn continuously without the risk of self-displacement on account of unbalanced weight. The battery back may be easily and quickly replaced. As an additional benefit, the head harness may be weather protected with a hat adornment that accommodates controls for the harness.

### SUMMARY OF THE INVENTION

The invention is head brace supporting a head light and a battery. The head harness includes the forward band, the rear band, the top band and the temporal sections. Substantially in the center of the forward band is a light source attachment. The light source attachment comprises a support arm having a fastener end attaching to the forward band and a distal end supporting a headlight. An adjustment arm spans the space between the fastener end and the distal end. The adjustment arm having at least one universal joint for pivoting the light source to achieve the most accurate angle of light.

The forward band forms an arch that is intended to encircle the frontal portion of the user's head. The arch of the forward band is terminated by a temporal section on both ends of the forward band. The surface of the forward band, and all surfaces of the head harness that are in contact with user's head, may feature patting. Either or both temporal sections contain an integrated electrical control for the headlight having an on/off switch and a beam intensity control.

The rear band forms the rear portion of the headband. The rear band contains an elliptical portion designed to wrap around the parietal portion of the wearer's head. Each end of the elliptical portion ends at a base of a short vertical section. The opposite end of the vertical section is attached to the temporal section. The attachment to the temporal section may be through an oscillating hinge which would then be used to control the angle of the rear section with respect to the location of the parietal portion on the wearer's head. The elliptical section is made of two half sections, which are held together with a sleeve. The sleeve has an adjustment control that is used to increase or decrease the distance between the two half sections thereby decrease the circumference of the headband.

The top band of the harness is still another elliptical arch, which encircles the head of a wearer. The terminal ends of the band are attached to the top part of the temporal section. The bottom surface of the temporal section may be padded for increased comfort. Alternatively, the padding is part of a removable sheath which may encase the top band. The top band prevents the harness from sliding down along the user's head.

In the center of the top band forms a proximal end for a rod, that forms an arch and descends toward the rear band, having a terminus end approximately midway between the top band and the rear band. The terminus end, the rod intersects with a flexible band that spans the temporal sections and provides an additional bond that immobilizes the harness on top of user's head.

The terminus end is made in form of a hook to snack a loop located on a battery pack or a battery caddy. The rod possesses sufficient structural rigidity to support with battery pack without twisting downward toward the wearer's head. At the same time the rod permits sufficient elasticity to permit the rod to function as a leaf spring that is biased in the direction away from the wearer's head, or in any direction. This feature enables the wearer of the headband to walk about in performing his or her activity, without feeling the weight of the battery pack, and without worry that the battery pack will twist off and become detached from the harness.

The wiring emanating from the terminals of the battery pack runs inside the body of the rod and inside the top band to the controls on the temporal sections. The headlight is connected to the controls with wiring that is encased inside the frontal band.

The headband structure may be wrapped inside a fabric cover to protect the wearer from the cold. The fabric cover may be represented in the form of a pull-on hat. Such a pull-on hat would contain lateral openings for insertion of light controls of the temporal sections. The openings further function to secure the harness within the hat.

It is an object of the present invention to create a headlight invention that can be worn by a user for prolonged periods of time.

It is another object of the present invention to create a headlight that is perfectly balanced while being worn.

It is another object of the present invention to create a balanced headlight that can be sized on the fly to fit many head sizes.

It is still another object of the present invention to create a headband with a headlight

### BRIEF DESCRIPTION OF THE DRAWINGS

FIG. 1 is a sideview of the head harness.

FIG. 2 is a top view of the harness.

FIG. 2A is a figure of a removable component.

FIG. 3 is a detailed diagram of the carrier rod for the battery pack.

FIG. 4 is a detailed diagram of the battery pack.

FIG. 5 is another sideview of the head harness.

FIG. 6 is a demonstration of the fabric hat wrapping around the harness.

FIG. 7 is a sideview of the fabric hat wrapping the harness.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

Turning now descriptively to the drawings, in which similar reference characters denote similar elements throughout the several views. The figures refer to a preferred embodiment, implicatively including all other embodiments enabling the inventive concept of the present invention.

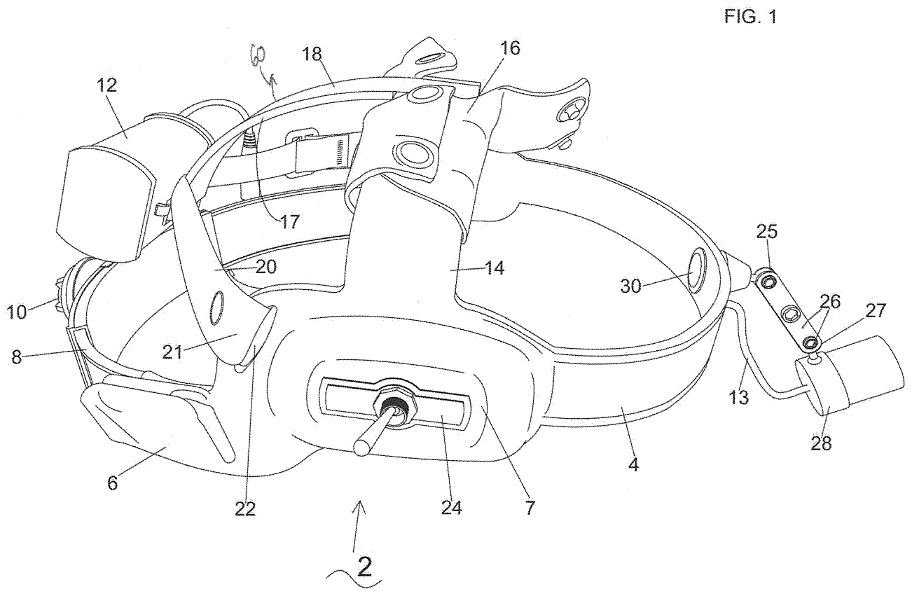

FIG. 1 shows the head harness 2, comprised of the forward section 4, the rear section 6, the temporal sections 7 having electrical controls 24. The temporal section forms a connecting bridge between the terminating ends of the rear band 6, the forward band 4, the top band 14 and the elastic band 20.

The length of the rear band 6 may be adjusted using a sleeve section 8. The rear band 6 is formed from two ends that are linked by a sleeve section 8. The adjustment mechanism 10 is rotated in one direction to shorten the rear band 6 and in rotated in the opposite direction to elongate it.

Substantially in the center of the forward section 4 is a connection 30 of the light source 28. The light source 28 may be an incandescent light or an LED light, or any other light producing bulb known in the art. The light source 28 is connected to the forward section 4 with an arm 26. The arm 26 is intended to suspend the light source 28 between a user's eyes and substantially at the same level as forward vision of the user. The angle of the arm 26 may be adjusted using the first and second joint 25 and 27 respectively.

Also shown in FIG. 1 is a battery 12 mounted on the rod 18. The rod 18 emanates from the top band 14 and is biased to spring away from a wearer's head in the direction 60. The existence of springiness in the direction 60 ensures that the battery 12 does not lay on a wearer's head but is actually supported entirely by the rod 18. The battery 12 is wired to the controls 24 on the temporal sections 7, which connects the electrical flow to the light source 28. The wiring 13 runs within the bands of the harness and is thoroughly insulated and protected from harming the user or being damaged by the elements.

All or some of the structural elements of the harness, are protected by padding 17 or soft sheathing 16, some or all of which may be removable.

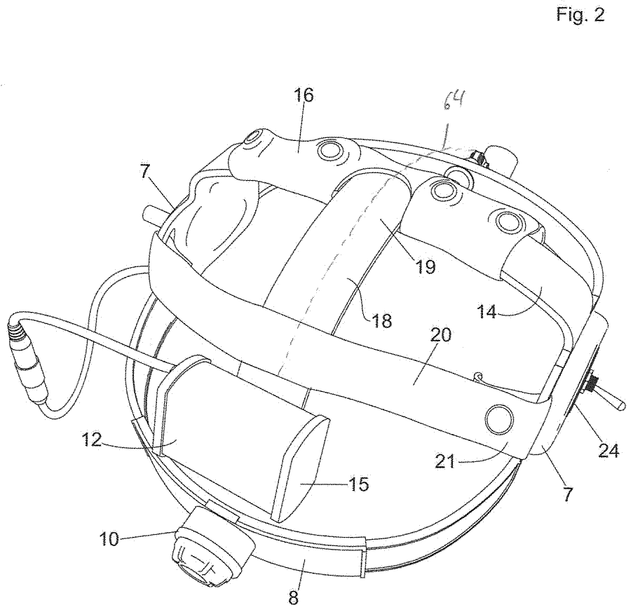

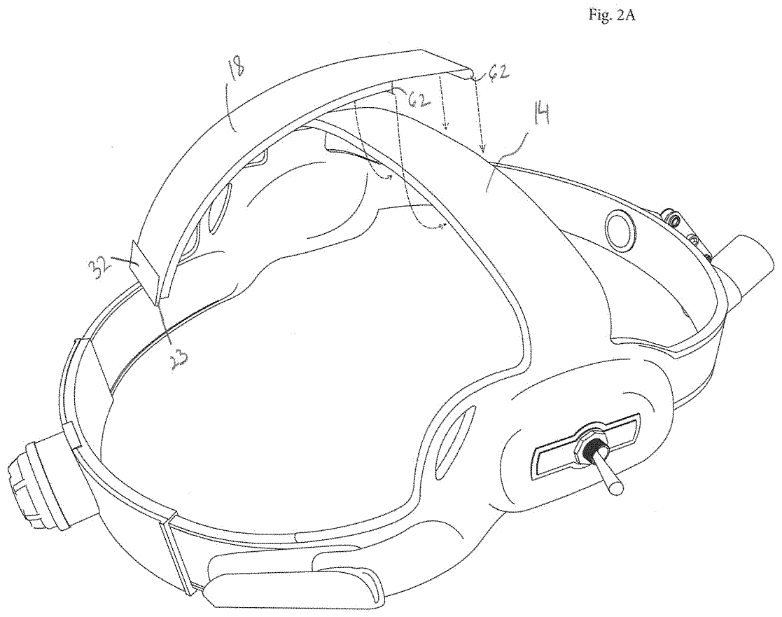

FIGS. 2 and 2A are a more detailed diagram of a battery 12 mounted onto the rod 18. The rod 18 may be one unit with the top band 14. The rod 18 may contain fastener means for attaching to band of any existing headlight, which provides some type of top band 14. The rod 18 provides two important functions. One is that it helps keep the harness 2 balanced, by ensuring that the presence of the heavy battery 12 does not skew the center of gravity. For the device. In the harness 2 shown, the two heaviest components, namely the light 28 and the battery 12, are mounted along the same axis 64 on the opposite sides of the device. This way The device 2 does not tend to slide in any particular direction due to a lack of balance. Furthermore, by keeping the battery 12 above the head and above most of the other components of the harness 2, the center of gravity is not easily changed by introducing different or heavier batteries. The rod 18 may be unitary with the top band 14 or may be mounted onto an existing band 14 using the snap tabs 62 or the sheath 16. The rod 18 is made of elastic materials that provide sufficient structural rigidity to withstand the weight of the battery 12.

The bands of the harness 2 should preferably be manufactured out of steel, alloys or polymeric materials. The elastic band 20 is used to reduce the distance between the temporal sections 7 to achieve a better fit. The elastic band is also designed to temper the elastic pull in the direction 60 of the rod 18.

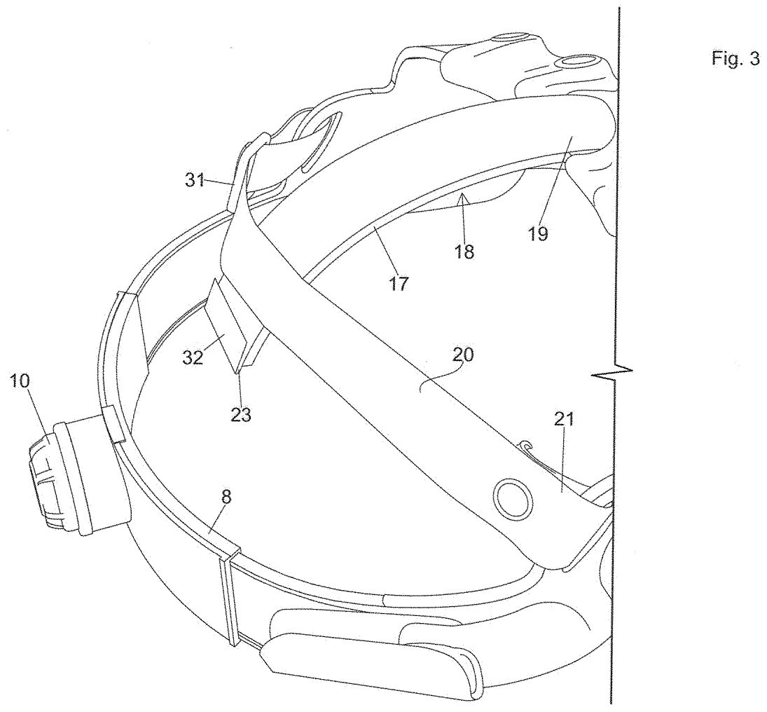

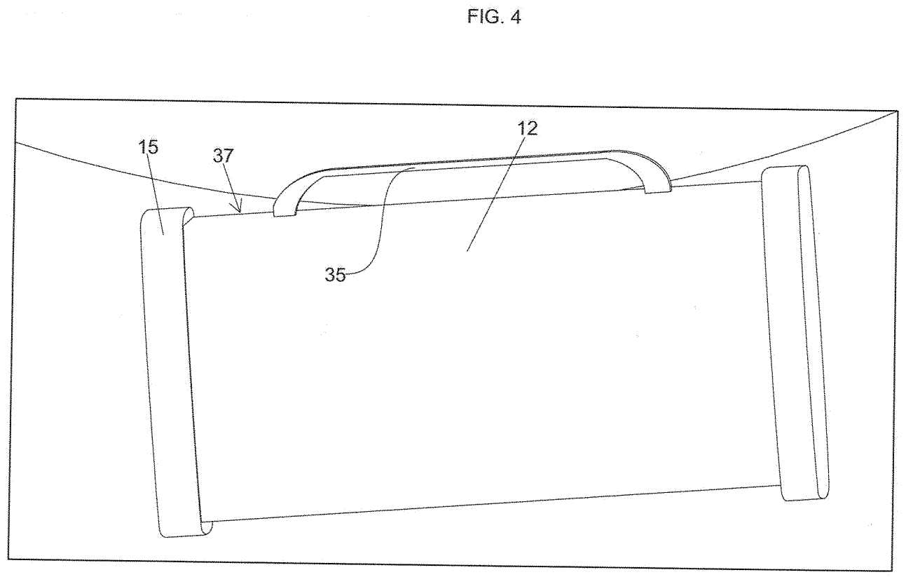

FIGS. 3 and 4 demonstrate the mounting point of the battery 12. The battery contains a loop 35, along the back surface 37 that fits unto the latch 32, located at the terminus end 23 of the rod 18. Alternatively, the loop 35 may be located on the caddy 15 and separate from the battery 12. The latch 32 may be in a form of a socket for accommodating the energy source, namely, a battery 12. The elastic band helps keep the rod 18, which is biased to bend in an upward direction, under tension. The preferred battery may be a lithium-ion or a cadmium battery having a voltage proportionate with the particular light source 28 that is implemented with any given embodiment. A solar energy source or a kinetic energy converter may also be implemented to provide either primary or supplemental energy for the light source 28.

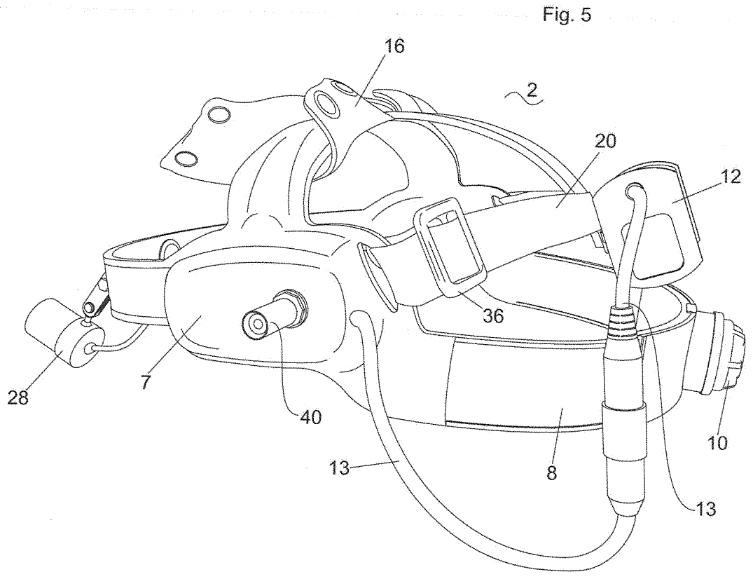

FIG. 5 demonstrates additional controls integrated into a terminal section 7, in this case a dimmer 40. There is no particular location requirement for either the on/off switch 24 (FIG. 1) or a dimmer 40. Rather, any of the switches may be disposed on any part of the harness 2 or the light source 28. Also shown in FIG. 5 are the rear band 8 with a rear band tightening mechanism 10, the battery 12, and the wiring 13. The loop 36 of the elastic strap 20 may be used to adjust the length of the elastic strap 20, and thereby also adjust the size of the harness 2.

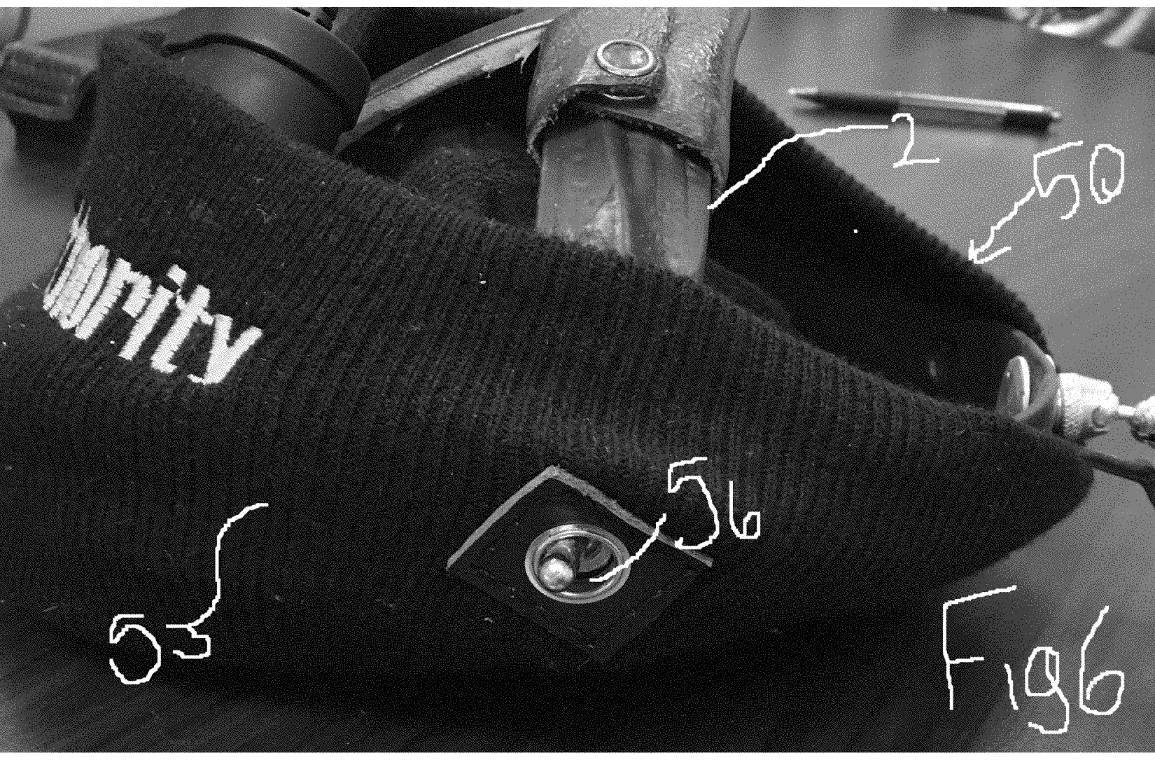

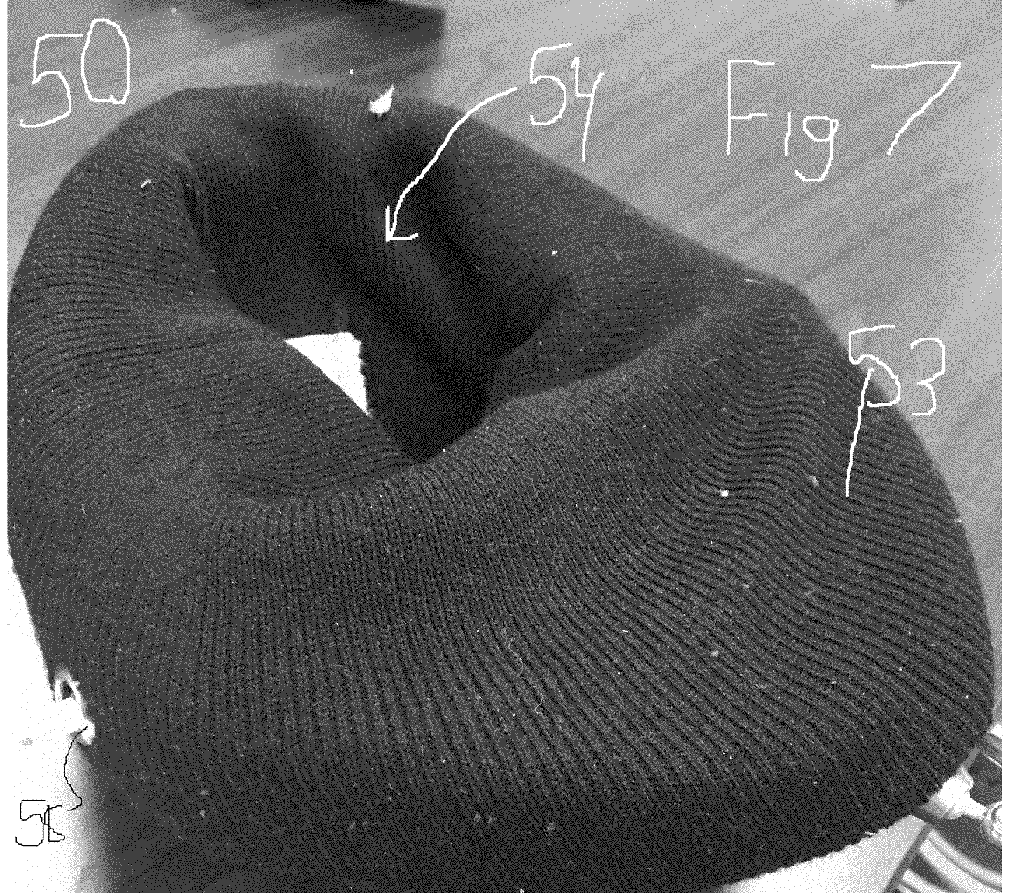

FIGS. 6 and 7 demonstrate the protective fabric wrap 50. The protective fabric 50 is intended to protect the wearer of the harness 2 from the cold and other elements. One challenge facing the wearer is the constant activity out in the cold. Integrated components, such as the light source 28 and switches 24 and 40 are mounted onto the harness, making it difficult to adopt significant protection against the elements, without compromising the effectiveness of the harness.

FIG. 7 demonstrates the under side of the fabric wrap 50 once it has been wrapped over the harness. The cavity 54 is inserted over a user's head. The walls of the fabric 53 are then stretched over the harness, with electronic controls inserted through the openings 58.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. The head based light source comprising: a head harness having a forward band, a rear band, and a top band; wherein terminal ends of each said forward band, said rear band and said top band terminating in temporal sections, said temporal sections being on each side of said head harness; a light suspended from said forward band; an energy source, said energy source mounted on a rod, said rod mounted on a top portion of said harness, said rod having sufficient structural rigidity to support said energy source; and a wiring system connecting said energy source to said light and a light switch located along said harness.

2. The head based light source of claim 1, further comprising a fabric covering that is capable of wrapping around a head harness to provide additional warmth to the wearer.

3. The head based light source of claim 1, further comprising an elastic strap, said elastic strap providing another and that spans a distance between said temporal sections.

4. The head based light source of claim 1, wherein said rod is removable.

5. The head based light source of claim 4, wherein said rod further comprising snap tabs on one end for mounting on a top band and said rod having snagging means substantially near its opposite end for securely mounting said energy source.

6. The head based light source of claim 4, wherein said rod further comprising an elastic sheath on one end, said elastic sheath wrapping around said top band, and said rod having snagging means substantially near its opposite end for securely mounting said energy source.

7. The head based light source of claim 1, wherein a light source is a dimmer,

8. The head based light source of 1, wherein said light source is mounted to said harness over a rod; wherein one end of said rod connecting to said forward band and wherein a second end of said rod connecting to a back of said light source, such that said light source is suspended substantially between eyes of a wearer.

9. The head based light source of 4, wherein said light source is mounted to said harness over a rod; wherein one end of said rod connecting to said forward band and wherein a second end of said rod connecting to a back of said light source, such that said light source is suspended substantially between eyes of a wearer.

10. The head based light source of claim 9, wherein said one end and said second end of said rod are ball joints.

11. The head based light source of claim 1, wherein said rear band having a sleeve, wherein said sleeve slides over said rear band to expand or contrast a total circumference of said band.
